(19) United States
(12) Patent Application Publication
(10) Pub. No.: US 2005/0254035 A1
(43) Pub. Date: Nov. 17, 2005

(54) Multi-photon lithography

(75) Inventor: Robert Frankel, Rochester, NY (US)

Correspondence Address: FISH & NEAVE IP GROUP;ROPES & GRAY LLP, ONE INTERNATIONAL PLACE, BOSTON, MA, 02110-2624, US

(73) Assignee: Chromaplex, Inc., West Henrietta, NY (US)

(21) Appl. No.: 10/843,806

(22) Filed: May 11, 2004

(51) Int. Cl. G03B 27/54

(52) U.S. Cl. 355/69; 355/71; 355/53; 250/492.2; 250/492.22

(57) ABSTRACT

A system and method for patterned exposure of a photoactive medium is described wherein a pulsed optical beam with a high peak-power is stretched in the time domain to reduce the peak power while maintaining the average power. The stretched pulse illuminated a pattern, such as a transparent or reflective photolithography mask. The pattern is then imaged onto the photoactive medium after recompressing the beam. This arrangement prevents damage to the mask by the high peak power of the pulsed optical beam.

### BACKGROUND OF THE INVENTION

The invention relates to photolithography in general, and more particularly to a device and method for producing two- and three dimensional patterned structures with a photolithography mask by a multi-photon optical process.

Non-linear optical processes can occur in molecular and atomic structures when the focused optical field reaches an optical power density of approximately 10⁸ W/cm². Such non-linear optical processes can include frequency conversion caused by higher order effects in the electric susceptibility as well as multi-photon absorption.

Because nonlinear optical and multi-photon processes are super-linear, they require a high optical power density in the material of interest to achieve a high efficiency. However, even with a pulsed laser light source with short pulse duration in the order of picoseconds to femtoseconds and a relatively low average power, the high peak-power pulses can still damage materials and/or structures placed in the optical beam. For example, a transmissive or reflective mask illuminated by a high peak-power pulse optical beam may be damaged and even destroyed by the intense optical and electrical field produced by the illuminating beam.

To limit damage to materials located from a pulsed high-power light source, for example the non-linear crystal used in solid state laser amplifiers, Strickland and Mourou (Opt. Commun. 56, 219 (1985)) developed a method referred to as Chirped Pulse Amplification (CPA). In this method a grating pair or highly dispersive optical fiber are used to “stretch” the pulse prior to amplification. In pulse stretching, the grating pair or fiber is used to arrange various frequency components of the original short pulse into a train of frequencies that then propagate sequentially in time through the amplifying medium. After amplification, another grating or pair of gratings is used to recompress the pulse in time which generates short pulses of very high peak-power which can be produce the desired non-linear optical effects.

It would therefore be desirable to provide a system and method for patterned exposure of a photoactive medium by a pulsed optical beam with a high peak power, whereby damage to the optical component defining the pattern, such as a photolithography masks, can be prevented or at least limited.

### SUMMARY OF THE INVENTION

The exemplary methods and systems described herein relate, inter alia, to the transfer of an optical image from a photolithography mask into a photoactive material by using a pulsed high peak-power optical beam.

According to one aspect of the invention, a microlithography system includes a light source that produces a pulsed optical beam with a wavelength, a pulse duration and a peak power. A following pulse stretcher receives the pulsed optical beam and increases the pulse duration of the pulsed optical beam while reducing the peak power. The stretched beam illuminates a mask having a pattern defined thereon, and an optical element then images the illuminated pattern onto a photoactive material. A pulse compressor is arranged between the mask and the photoactive material. The pulse compressor decreases the pulse duration and increasing the peak power of the stretched beam, thereby exposing the photoactive material with the high peak power.

According to another aspect of the invention, a method for patterned exposure of a photoactive medium includes the steps of producing a pulsed optical beam with a high peak-power, stretching the pulse duration of the pulsed optical beam to reduce the high peak-power, and illuminating a pattern with the stretched pulse. The method further includes the steps of recompressing the stretched illuminated pattern and imaging the recompressed illuminated pattern onto the photoactive medium.

Embodiments of the invention can include one or more of the following features. The photoactive material can be a photon-activatable photoacid generator that can be activated by single-photon, two-photon, or multi-photon processes, with the light source being a pulsed laser. The wavelength exposing the photoactive material can be shorter than the laser emission wavelength and can be generated, for example, by optical frequency conversion, such as second or third harmonic generation. The pulse stretcher and the pulse recompressor can each include an optical grating pair that preferably operates in first order. The pulse stretcher can also be made of a suitable length of optical fiber. The mask can be a programmable mask, for example, a mask composed of arrays of movable micro-mirrors. To shape the wavefront and/or delay the phase of the stretched beam, a liquid crystal modulator can be placed in the optical beam path. The imaging resolution can be further enhanced by placing an index matching fluid between the optical element and the photoactive material.

The feature definition in the exposed photoactive material can be improved by micro-stepping or interleaving mask patterns by repeatedly imaging the recompressed illuminated pattern onto the photoactive medium with a relative offset between imaging steps, wherein a resulting separation between pattern features produced from different imaging steps is smaller than a diffraction-limited image of the pattern features.

This system and method is useful for the manufacture of integrated circuits that can have feature sizes of less than 100 nanometers, and for structured three-dimensional systems for medical applications, such as cardiac stents. The system and method can also be used to “print” three-dimensional optical devices such as photon crystals. Further features and advantages of the present invention will be apparent from the following description of several illustrated embodiments and from the claims.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIGS. 1a-1d show schematically a two-photon absorption process and an exposure region in a photoactive material;

FIG. 2 shows schematically a reduction in the feature size achievable with two-photon lithography;

FIG. 3 shows a micro-stepping approach to print features with finer pitch;

FIG. 4 shows a schematic diagram of a two-photon exposure system according to the invention;

FIG. 5 shows schematically a process for two-photon exposure;

FIG. 6 shows an exemplary programmable mask; and

FIG. 7 shows an arrangement for wavefront shaping using a phase modulator.

### DETAILED DESCRIPTION OF CERTAIN ILLUSTRATED EMBODIMENTS

The system described herein is directed to patterning a photoactive material, such as photoresist, applied on, for example, a wafer with a high peak-intensity optical beam, wherein the exposure is induced by simultaneously absorbing two photons which in the illustrated example have the same photon energy. In particular, the system described herein uses an optical projection-reduction system, similar to a projection mask aligner. However, unlike a conventional system, the short duration pulses of the exciting optical beam are first stretched to form pulses of longer duration with a smaller peak energy to prevent damage to the mask. These longer pulses then illuminate a patterned mask, whereafter they are recompressed, e.g., by another grating pair, and imaged onto the photoactive medium, such as photoresist, for example by a reduction optical system.

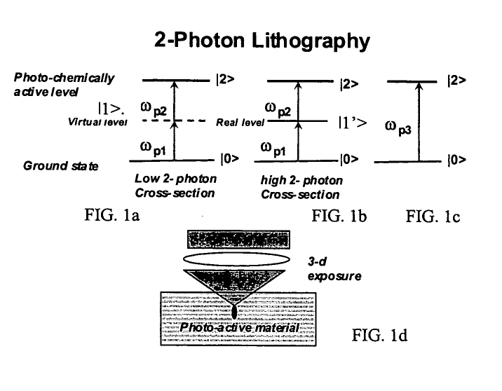

FIGS. 1a to 1d show schematically a two-photon process in an optically absorbing material. Photons having photon energies ωₚ₁ and ωₚ₂, wherein ωₚ₁ can be identical to or different from ωₚ₂, are absorbed in the material to produce a transition from a ground state |0> to an excited state |2>. The two-photon process can occur either via a virtual level |1>, as indicated in FIG. 1a, or a real level |1′>, as indicated in FIG. 1b. A transition via a virtual level tends to have a shorter lifetime than a transition via a real level and therefore also tends to be less efficient. The energy spacing between levels |0> and |2> is ωₚ₃≅ωₚ₁+ωₚ₂, neglecting level splitting and phonon contributions, as shown in FIG. 1c. As shown schematically in FIG. 1d, because two-photon processes are proportional to the square of the incident photon energy, the photoactive material tends to be exposed in a small area where the peak intensity of the focused beam is high.

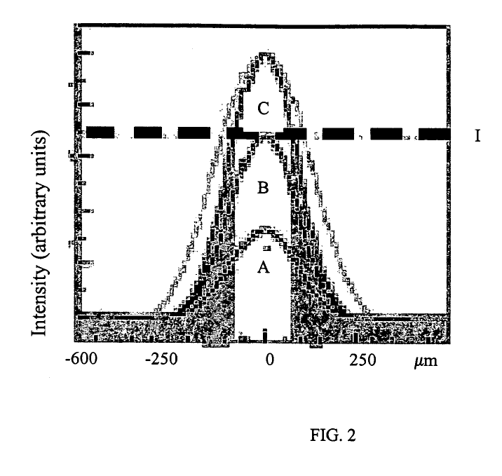

FIG. 2 shows the reduced feature size achievable using two-photon lithography. In a two-photon process, the photoresist is only exposed where the intensity of the high peak-power optical beam exceeds the threshold level schematically indicated by the dashed red line I, whereas in one-photon processes, photoresist is typically exposed at a much lower intensity. The feature size is a function of, for example, the γ-value of the resist, etching characteristic, illumination geometry, etc. In general, the pitch p (or line repetition spacing) that can be printed in semiconductor lithography is equal to approximately

$$p = k \cdot \frac{λ}{NA} ,$$

wherein λ is the exposure wavelength, NA is the numerical aperture of the optical system and k is a proportionality constant defining the finest pitch that can be printed. The smallest k equals k=0.5, where the highest order diffraction is captured at the edge of the imaging lens. Sophisticated imaging techniques such as phase shifting masks, optical proximity correction and off axis illumination allow the minimum printed feature to be less than p/2. Values as low as k=0.36 have been reported. In two-photon processes, the exposure threshold depends on I² so that, for example, side-lobes of the beam do not print. Accordingly, two-photon exposures may be able to produce feature sizes down to

$$p = 0.12 \cdot \frac{λ}{NA}$$

or less.

In addition, high-power laser pulses of short duration can be efficiently frequency-doubled or frequency-tripled. Two-photon lithography today uses typically an exposure wavelength of 750-800 nm, which can be doubled or tripled to, for example, 260-400 μm. This has the advantage that photoresists designed for exposure wavelengths of 193 nm or 157 nm wavelength can be used, which are transparent at the doubled or tripled exposure wavelength of 260-400 nm. It follows from the above equation that for a system having a numerical aperture NA=0.9 and an exposure wavelength of 270 nm a minimum feature size of 36 nm could be printed at a pitch of 150 nm (k=0.5).

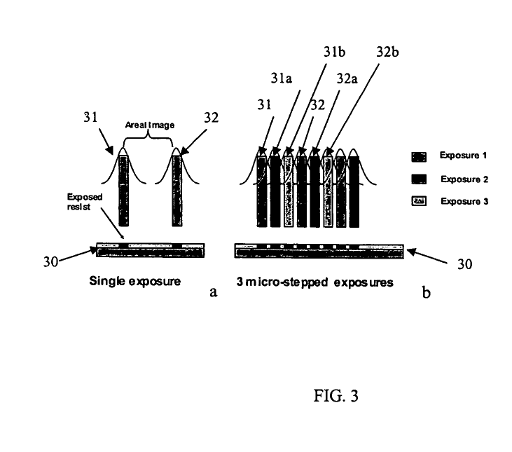

A concept of printing a smaller feature size than the pitch is schematically illustrated in FIG. 3. As mentioned above, the I² dependence of the two-photon exposure allows resolution equal to 3-4 times the Raleigh limit, making the exposed area much smaller than the Gaussian width of the incident beam. FIG. 3a indicates schematically the exposure width for two-photon exposure, with the expected width for conventional single-photon exposure being about 3 times greater. In a single two-photon exposure, two features 31 and 31 are exposed. Because the width of the exposed features is quite narrow, regions between these peaks 31, 32 can be exposed by, for example, stepping mask 30 by a distance d that is smaller than the spatial separation D of the features on mask 30. FIG. 3b shows an exemplary stepped exposure, showing exposure of the features 31, 32 in the first exposure step (identical to the exposure of FIG. 3a), followed by exposure of the features 31a, 32a shifted by offset d, and thereafter by exposure of the features 31b, 32b shifted by another offset d. As a result, the two-photon exposure can be “micro-stepped,” with the step size for depicted two-photon exposure being about 3 times smaller than for single-photon exposure. Furthermore, the secondary lobes in a Gaussian beam do not print, because they are below the non-linear two photon exposure threshold, allowing very fine point-by-point scanning for image generation.

However, point-by-point scanning is time-consuming and therefore unsuitable for volume-production of wafers. Modern wafer fabs use projection mask aligners and steppers, allowing rapid area exposure of photoresist with high resolution and high throughput. Here a mask, or reticule, with an image pattern is imaged with 4-10 times reduction onto a layer of a photoactive material, e.g. photoresist, coated on the wafer. This image is subsequently developed and device features are defined in a number of semiconductor process steps. Typically, in excess of ninety 12 inch wafers may be processed per hour with a single stepper or scanner. Up to 25 masking levels may be required to process the most advanced CMOS process wafers.

As mentioned above, a photoactive material activated by a two-photon exposure process requires a high peak-power beam to be efficient; however, such a high peak-power beam can damage the mask (which after all is an optical absorber). It would therefore be advantageous to expose the mask with a beam generated by a pulsed light source, such as a laser beam, that has a smaller optical peak power than the beam required for two-photon exposure of the photoresist, while maintaining approximately the same average beam power to achieve adequate wafer throughput. This can be accomplished by first stretching the optical pulse generated by the light source (laser) for exposing the mask, and subsequently recompressing the pulse with the impressed mask pattern for exposing the photoactive material by a multi-photon processes.

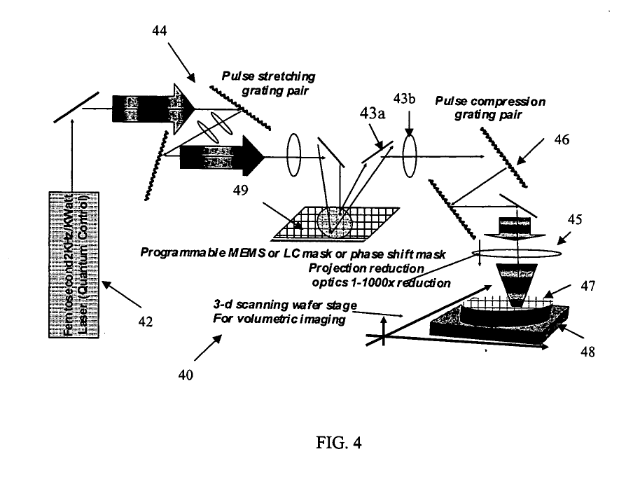

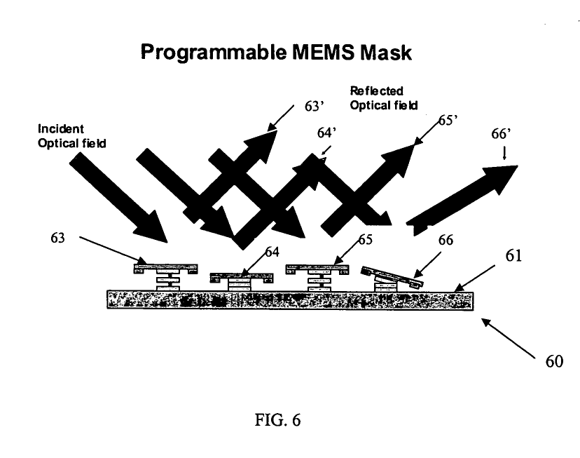

Turning now to FIG. 4, a pulsed laser photolithography system 40 includes an exemplary pulsed laser 42 emitting femtosecond pulses with a peak power of several kW and a repetition rate of, for example, 2 kHz. A laser of this type is commercially available. The high peak-power laser beam then traverses a pulse-stretcher, for example a grating pair 44, where the time duration of the laser pulse is “stretched” from, for example, femtoseconds to picoseconds. Other types of pulse stretchers, such as optical fibers, are known in the art. Stretching the pulse also decreases its peak power by approximately the ratio of the pulse durations of the stretched and unstretched pulse, for example, by a factor of 100-1000. The stretched pulsed laser beam then illuminates a mask 49 which can be designed to withstand the reduced peak power of the stretched laser beam. The mask 49 can be a conventional mask with a predefined mask pattern or can be a programmable mask, such as a micro-machined MEMS mask, depicted in FIG. 6, or a liquid crystal (LC) mask, or a phase mask.

The imaged beam then passes through suitable imaging optics 43a, 43b and a pulse-compressor, such as grating pair 46, and is imaged onto a wafer 47 or another suitable substrate coated with or formed of a photoactive medium (e.g., photoresist) that can be placed in a reduction mask-aligner/stepper 48. The aligner/stepper 48 can be of a conventional design used in the semiconductor industry. The projection/reduction optics 45 of the mask-aligner/stepper 48 can reduce the imaged feature size of mask 49 by a factor of up to 1000.

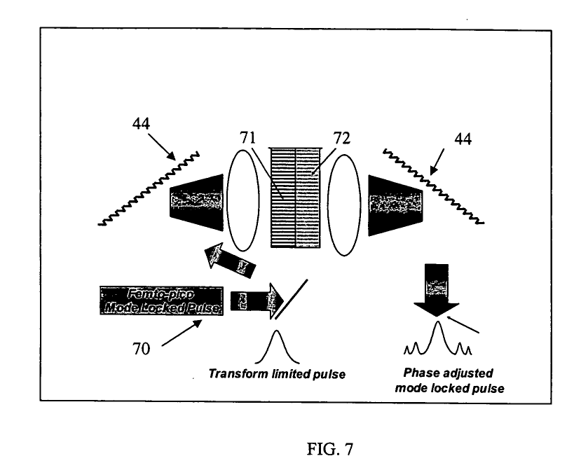

The pulse compression gratings should have high reflectivity across the bandwidth of the laser pulse and also be designed to have very little wavefront distortion. A distortion of less that λ/10-λ/20 is desirable. In addition, with broad bandwidth laser pulses optical dispersion may occur in the projection optics. This can be compensated for by acousto-optic or liquid crystal array phase modulator systems, located in the spectrally dispersed optical beam (see, for example, FIG. 7).

The photomask 49 can not only be imaged onto the surface of wafer 47 to expose the photoresist at the wafer surface, but due to the threshold exposure associated with two-photon processes can also expose the photoresist selectively at a certain depth in the photoresist layer. Accordingly, three-dimensional features can be defined in the photoresist by the nonlinear two-photon exposure process.

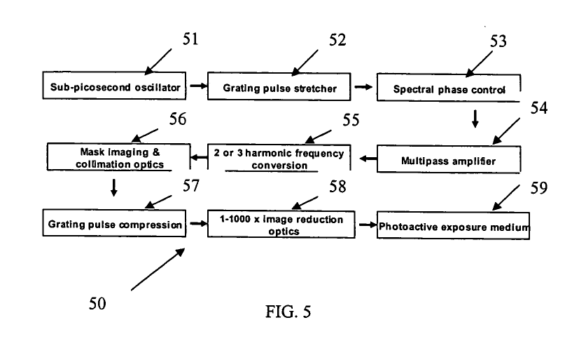

FIG. 5 summarizes the major elements and process steps of the two-photon exposure system 40 and process 50. A sub-picosecond (femtosecond) oscillator/laser 51, produces high peak-power optical pulses that are stretched by pulse stretcher 52. A spectral phase control 53 can be inserted in the beam to adjust the optical wavefront, for example, for amplification 54 and/or harmonic conversion 55. Keeping in mind that the peak power is reduced at this point due to pulse-stretching, the stretched (and optionally frequency-doubled or frequency-tripled) beam is imaged 56 by the photolithography mask and the pulse is recompressed 57. Image reduction optics 58, for example, of a type employed in a photolithography stepper, but possibly adapted to imaging at shorter wavelengths, can then be used to image the recompressed and patterned beam onto the photoresist on the wafer for defining, for example, a device pattern.

Because in the nonlinear two-photon exposure process the rendered feature size can be considerable smaller than the pitch, as described above with reference to FIG. 3, a relatively “coarse” mask, for example, a mask with a feature size of about 1 μm, can be used, while still achieving adequate submicron resolution. FIG. 6 shows schematically a controllable mask implemented, for example, as a MEMS array 60. The MEMS array may have a pixel size of 10 to 20 microns. In this instance a projection reduction minification of 100-200 may be used to print the smallest features. The individual MEMS elements 63, 64, 65, 66 are formed in or secured to a substrate 61 which can be made of silicon. The top surface of the MEMS elements 63, 64, 65, 66 can be formed as micro-mirrors by applying, for example, a dielectric or metallic coating. Micro-mirrors, MEMS mirror arrays and processes for manufacturing such mirrors are known in the art. In one practice, the micro-mirror array 60 can operate as a phase mask, whereby the mirrored top surface of the MEMS elements 63, 64, 65 is displaced by fractions of a wavelength perpendicular to the substrate 61 without changing the relative orientation between the top surfaces of MEMS elements 63, 64, 65. This changes the phase relationship between the reflected light beams 63′, 64′, 65′ so that the MEMS array 60 operates as a programmable phase mask. In another practice, MEMS mirrors, such as the exemplary mirror 66, can be tilted so that the deflected beam 66′ is moved out of the optical field of the collection optics, for example, mirror 43a and lens 43b in FIG. 4. The micro-mirrors can be, for example, electrostatically actuated, but other types of actuators, such as piezoelectric actuators, can be employed.

FIG. 7 shows schematically an arrangement 70 for spectral phase control to shape a wavefront. The exemplary spectral phase control arrangement 70 uses a liquid crystal phase modulator having a first part 71 to adjust the phase, and a second part 72 to adjust the polarization of the illuminating stretched beam. The arrangement 70 can also be used to adjust the amplitude of the stretched beam. Other phase modulators known in the art can be used instead of a liquid crystal. Although FIG. 7 shows the phase control arrangement 70 as being located between two gratings of pulse stretcher 44, the phase control arrangement 70 can be placed at any location in the optical path between the laser 42 and the photomask 49.

Conventional ultraviolet (UV)-sensitive photoacid generators (PAG) such as diaryliodonium and triarylsulfonium cations, have been used for two-photon microfabrication. Other materials, such as bis[(diarylamino)styryl]benzene with attached sulfonium moieties with orders of magnitude larger two-photon cross-sections have been proposed. I.e., with photoresists for two-photon lithography readily available, the aforedescribed exposure system will offer unprecedented feature definition and resolution in two-dimensional and three-dimensional photolithography.

The disclosed system and method can therefore advantageously provide:

1) An area exposure with a resolution that is significantly higher than can be achieved with standard one-photon projection reduction lithography—because photochemistry is initiated only at the peaks of the optical field, which can therefore smaller features than the diffraction-limited resolution of a microscope or reduction lens.

2) A three-dimensional exposed pattern in the interior of a thick layer of a photoactive medium. Unlike in one-photon projection reduction lithography where significant photo-activation can occur outside of the focal region in the converging and diverging optical beam, the two-photon process is only efficiently activated in the high intensity focal volume of the image.

While the invention has been disclosed in connection with the preferred embodiments shown and described in detail, various modifications and improvements thereon will become readily apparent to those skilled in the art. For example, instead of using a photoactive medium responsive to two-photon processes, a medium operating with single-photon excitation or by excitation by three or more photons can also be used, as long as a short pulse duration and high peak power is desirable for the exposure. Moreover, the photolithography mask can operate in reflection or transmission. This could be advantageous, for example, for improving the thermal management during the exposure. Accordingly, the spirit and scope of the present invention is to be limited only by the following claims.

1. A microlithography system comprising
a light source producing a pulsed optical beam having a wavelength, a pulse duration and a peak power;
a pulse stretcher that receives the pulsed optical beam and increases the pulse duration of the pulsed optical beam while reducing the peak power;
a mask having a pattern defined thereon and illuminated by said stretched beam;
an optical element that images said illuminated pattern on a photoactive material; and
a pulse compressor disposed between the mask and the photoactive material, said pulse compressor decreasing the pulse duration and increasing the peak power of the stretched beam.

2. The system of claim 1, wherein the photoactive material is a photon-activatable photoacid generator.

3. The system of claim 1, wherein the photoactive material is a two-photon activatable photoacid generator.

4. The system of claim 1, wherein the photoactive material is a multi-photon activatable photoacid generator.

5. The system of claim 1, wherein the pulse stretcher comprises a grating pair.

6. The system of claim 1, wherein the pulse stretcher comprises an optical fiber.

7. The system of claim 1, wherein the pulse compressor comprises a grating pair.

8. The system of claim 1, wherein the imaging optics comprises a reduction optics that reduces the feature size of the patterned mask.

9. The system of claim 1, wherein the light source is a laser.

10. The system of claim 1, wherein a wavelength of said stretched beam is frequency-converted from said wavelength to another wavelength that is shorter than said wavelength.

11. The system of claim 10, wherein said other wavelength is produced by second, third or fourth harmonic generation.

12. The system of claim 1, wherein the mask is a programmable mask.

13. The system of claim 12, wherein the mask comprises a plurality of movable mirrors.

14. The system of claim 12, and further comprising a liquid crystal modulator disposed in said stretched beam before the mask, said liquid crystal modulator modulating a phase, an amplitude or a polarization of said illuminating stretched beam, or a combination thereof.

15. The system of claim 1, and further comprising an index matching fluid disposed between the optical element and the photoactive material.

16. The system in claim 5, wherein said grating pair operates in a low diffraction order.

17. The system in claim 7, wherein said grating pair operates in a low diffraction order.

18. Method for patterned exposure of a photoactive medium, comprising:
producing a pulsed optical beam with a high peak-power;
stretching a pulse duration of the pulsed optical beam to reduce the high peak-power;
illuminating a pattern with the stretched pulse;
recompressing the stretched illuminated pattern; and
imaging the recompressed illuminated pattern onto the photoactive medium.

19. The method of claim 18, wherein the recompressed illuminated pattern activates a photoactive process in the photoactive medium through multi-photon absorption.

20. The method of claim 19, wherein the photoactive process produces a pattern in the photoactive medium having a feature size that is smaller than a diffraction-limited image of a corresponding feature size of the pattern.

21. The method of claim 20, wherein the pattern in the photoactive medium is produced by repeatedly imaging the recompressed illuminated pattern onto the photoactive medium with a relative offset between repeated imaging steps, wherein a resulting separation between pattern features produced from different imaging steps is smaller than a diffraction-limited image of the pattern features.
